(19) United States
(12) Patent Application Publication
(10) Pub. No.: US 2005/0097981 A1
(43) Pub. Date: May 12, 2005

(54) Handlebar clamp assembly

(75) Inventor: Andrew C. Renshaw, Macclesfield (GB)

Correspondence Address: OLIFF & BERRIDGE, PLC, P.O. BOX 19928, ALEXANDRIA, VA, 22320, US

(73) Assignee: RENTHAL LIMITED, Stockport (GB)

(21) Appl. No.: 10/817,942

(22) Filed: Apr. 6, 2004

(30) Foreign Application Priority Data
Nov. 12, 2003 (GB) 0326352.2

(51) Int. Cl. B62K 21/12

(52) U.S. Cl. 74/551.8

(57) ABSTRACT

For attachment of a handlebar to a motorcycle body a clamp assembly comprises a pair of clamp elements which securely clamp around a central location of a handlebar without play. Respective support means, such as cradles mount respective end portions of the clamp elements with bearing elements disposed between each support cradle and the clamp elements in order to permit relative axial rotation. A substantially rigid member is fixed to and extends between the support cradles and resilient means, such as washers, or pads or inserts of various shapes and materials, are disposed between the clamp elements and this rigid member so as to permit rotational play between the clamp elements and the support cradles about the longitudinal axis of the central location of the handlebar, but either minimize rotational play between the clamp elements and the support cradles in the other directions, namely about vertical and horizontal axis, or at least allow only limited rotational play therebetween in these other directions.

### TECHNICAL FIELD OF THE INVENTION

This invention concerns a clamp assembly for attachment of a handlebar to a motorcycle body. This is generally accomplished by mounting the clamp assembly onto a part of the body called a yoke, and clamping a central location of the handlebar in the assembly.

### BACKGROUND ART

In a conventional arrangement for handlebar clamping, a lower part of the clamp has a shaft which is mounted onto the yoke by extending approximately vertically through a bearing of resilient material, such as an annular rubber bearing which may have a frustoconical configuration, or a waisted configuration as provided by a frustoconical portion or element and an inverted frustoconical portion or element. This bearing serves to transmit steering control from the handlebar to the yoke, to which the front wheel is attached by way of forks, and to damp vibration from the bike to the rider's hands and arms. Owing to the resilient nature of the bearing material and its location between the clamp shaft and the yoke, a small amount of rotation of the handlebar relative to the yoke is possible in three different ways. Firstly, slight rotation of the handlebar on its own longitudinal axis is possible. Secondly, slight rotation of the handlebar about a vertical axis is possible, i.e. fore/aft tilt. Thirdly, slight rotation of the handlebar about a horizontal axis is possible, i.e. up/down tilt. In other words, there are three degrees of freedom. The amount of freedom (or play) allowed depends on the relative softness or resilience of the rubber used in the bearing, but this is common to all three directions of rotation.

An object of the invention is to provide a clamp assembly whereby rotation of the handlebar relative to the yoke can be inhibited or prevented altogether in at least one, or preferably two directions.

In this respect, it is desirable to minimise or prevent play in the fore-aft tilt direction so that steering movements of the handlebar are transmitted substantially without play to the bike itself. Similarly it is desirable, particularly for a motorcycle used for motocross or other sports or cross country purposes to minimise or prevent play in the up-down tilt direction so that lifting and cornering movements of the handlebar are also transmitted substantially without play to the bike itself. On the other hand, it is always desirable to have a small amount of axial rotation play for shock absorption purposes and to prevent injury to the rider's wrists. With known clamping arrangements it is not possible, however, to separate the play permitted in these three directions.

### SUMMARY OF THE INVENTION

According to the present invention, a clamp assembly for attachment of a handlebar to a motorcycle body is provided which comprises clamp means adapted for secure clamping around a central location of a handlebar without play, respective support means adapted for mounting respective end portions of the clamp means, bearing elements disposed between each support means and the clamp means in order to permit relative axial rotation, a substantially rigid member adapted to be fixedly secured to and extending between the respective support means, and resilient means disposed between the clamp means and the rigid member so as to permit rotational play between the clamp means and the support means about the longitudinal axis of the central location of the handlebar, but minimise rotational play between the clamp means and the support means in the other directions, namely about vertical and horizontal axes.

The support means are intended, in use of the invention, to be connected rigidly to a motorcycle yoke, or alternatively to be formed integrally therewith.

In preferred embodiments of the invention the bearing elements and the resilient means are such as substantially to prevent any relative movement between the clamp means and the support means in either the fore-aft direction or the up-down direction, thereby substantially preventing play of the handlebar itself in these directions.

However, in other embodiments, the nature of the material or grade of material chosen for the bearing element or the resilient means, or the positioning of the resilient means between the rigid member and the clamp means, or variation in thickness or contouring of the resilient means may permit limited play in at least one of those directions, but how far this is possible will depend on the said positioning and/or variation or contouring and/or stiffness characteristics of the said resilient means.

### BRIEF DESCRIPTION OF DRAWINGS

The invention will be described further, by way of example, by reference to the accompanying drawings, in which:

FIG. 1 is a plan view of a preferred practical embodiment of a clamp assembly in accordance with the invention;

FIG. 2 is a side view of the same assembly as in FIG. 1;

FIG. 3 is an end view of the same assembly; and

FIGS. 4 and 5 are further end views showing rotational play in respective directions.

### DETAILED DESCRIPTION OF ILLUSTRATED EMBODIMENT

The illustrated clamp assembly comprises clamp means, in the form of upper and lower clamp elements 12, 14, support means in the form of respective support cradles 16 at each end of the lower clamp element 14 and a substantially rigid plate 18 which is secured across the top of the assembly to the respective cradles 16.

All these components are preferably made of aluminium, but other metals are possible.

The lower clamp element 14 has respective end sections 15 of U-shape in profile and a central section 13 which is enlarged adjacent to the end sections 15. The upper clamp element 12 is shorter than the central section 13 of the lower element 14, but wider. The upper element 12 and the central section 13 of the lower element 14 are each provided with four aligned apertures through which four bolts (not shown) threadedly engage to clamp the two elements 12, 14 together in facing disposition around a central location on a motorcycle handlebar (not shown). Thus the inner, opposing surfaces of these elements 12, 14 together provide a substantially cylindrical bore 19 which in use accommodates the handlebar. In use these clamp elements 12, 14 are tightly and non-rotatably clamped onto the handlebar with a large area of contact therebetween for maximum strength and minimum likelihood of stress or fatigue problems arising.

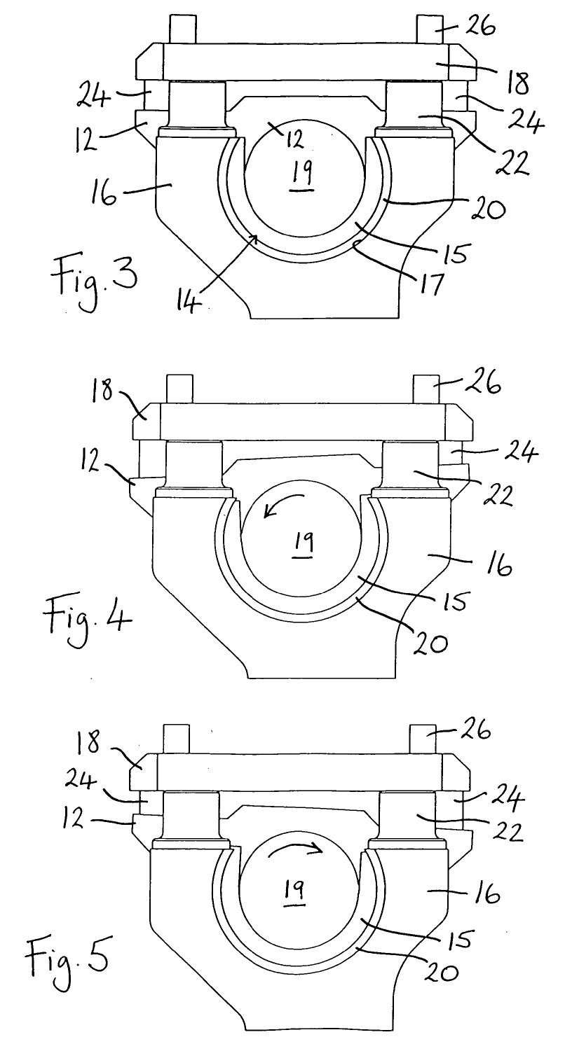

Each support cradle 16 is of a symmetrical, generally Y-shaped or forked configuration in profile, as is apparent from FIGS. 3 to 5. Each has an U-shaped inner support surface 17 upon which a bearing 20 of nylon or other suitable material is seated. These bearings 20 are also C-shaped or part circular in profile and have an outer surface corresponding to and contacting the inner surface 17 of the respective cradles 16. They are held captive in this position by inwardly projecting lips at each side of the mouth of the respective cradles 16. The bearings 20 have inner surfaces corresponding to the outer surfaces of the end sections 15 of the lower clamp elements 14, which are mounted therein, as shown in FIGS. 3 to 5. Thus these bearings 20 allow axial rotation of the handlebar, which is clamped between the elements 12, 14, relative to the supporting cradles 16. In other words, these bearing elements 20 allow relative rotation between the clamping elements 12, 14 on the one hand, and the support cradles 16 on the other hand, this rotation being about the common longitudinal axis of the components which is also co-incident with the axis of the centre of the handlebar being clamped.

As already mentioned, the plate 18 is rigidly clamped across the whole assembly, between the respective support cradles 16. However, this is accomplished by way of intervening spacer elements 22, of which there are four, located between the upper surface of each of the forks of the cradles 16 and the plate 18. Bolts 23 (see FIG. 1) clamp the plate 18 to the support cradles 16 and extend through the aforesaid spacer elements 22.

The plate 18 prevents any movement of the two support cradles 16 relative to each other about either a vertical or horizontal axis.

As shown in FIG. 1, the plate 18 has four access openings 21 which are aligned with the bolts securing the clamp elements 12, 14 together, so that a tool can be inserted for the purpose of tightening or loosening these latter bolts. There are also two more centrally located inspection apertures 25 which are to enable the assembly to be fitted accurately to the centre of the handlebar by alignment with markings on the bar.

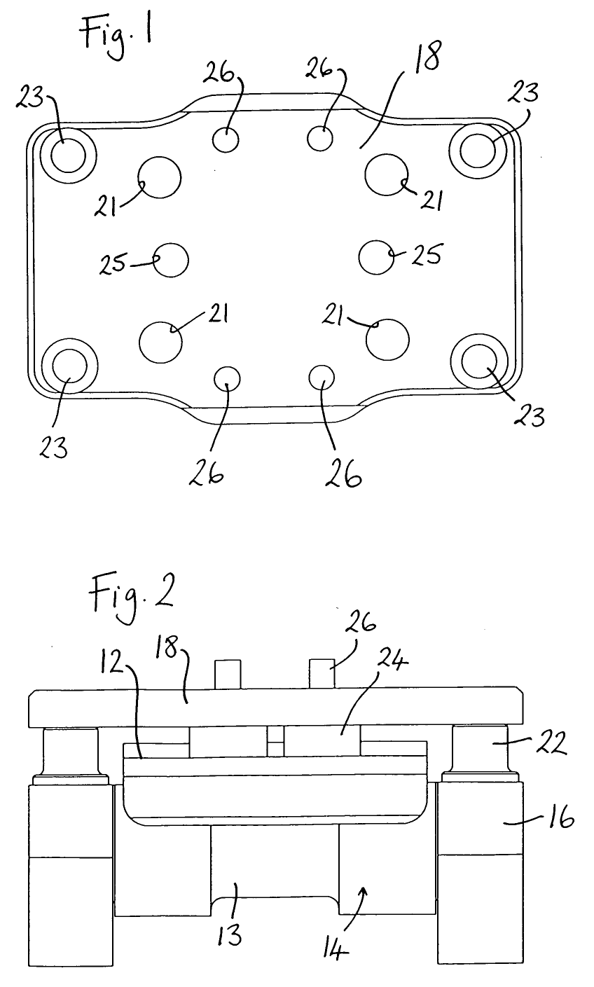

Resilient means in the form of four rubber washers 24 are mounted between the upper clamp element 12 and the rigid plate 18. These washers 24 are connected to the plate 18, for example by extending through apertures in the plate 18 and being secured by fasteners 26, which are depicted in a general form only in FIGS. 1 and 2. However, they may be fixed to the plate 18 in any suitable manner, including by adhesive. They are not however connected to the upper clamp element 12. Their lower surfaces are free to allow for variable compression relative to the abutting surface of the upper clamp element 12.

The aforesaid rotational movement which is permitted between the clamping elements 12, 14 holding the handlebar and the support cradles by virtue of the bearings 20 is limited by the resilient washers 24—specifically their deformability characteristics and their thickness—within the constraint of the distance between the plate 18 and the upper clamp element 12, which is fixed by the spacers 22.

FIG. 4 shows how the clamp elements 12, 14 tilt the washers 24 at the right hand side are compressed more as the handlebar is rotated anticlockwise (as shown) about its and longitudinal axis, and FIG. 5 shows, conversely, how the washers 24 at the left hand side are compressed more as the handlebar is rotated in the opposite direction (clockwise) as shown.

In the illustrated embodiment, with the washers 24 located fairly close to the centre of the assembly and the material of the bearings 20 fairly resistant to compression and fairly thin, play between the clamp elements 12, 14 (and the handlebar), on the one hand, and the support cradles 16, on the other hand, in the fore-aft or up-down directions (ie about vertical or horizontal axes)is substantially prevented. Thus only the controlled amount of rotational play about the longitudinal axis of the handlebar, as permitted by the washers 24, is possible.

The foregoing is illustrative and not limitative of the scope of the invention and many variations in detail are possible in other embodiments. In particular, both the clamp elements holding the handlebar and the support means, supporting these clamp elements and allowing relative rotation, may be of different configuration. Instead of spacers, there may be respective upper parts of different form above the support cradles, which may themselves be of different form. As regards the clamp elements, these may consist of substantially identical mating elements and/or need not be mounted as upper as lower elements. The resilient means need not be in the form of washers and could be in the form of one or more resilient pads or resilient inserts, which are at least partially countersunk, for example.

Also, in other embodiments it would be possible to allow play, selectively, in one or both of the fore-aft or up-down directions, and to differing degrees, in addition to the purely rotational play allowed in the above-described embodiment. This could be achieved by suitable choice of resilient means between the clamp means and the rigid member, or by having that resilient means of variable thickness, or by placing individual resilient elements (eg washers, pads or inserts) further from the centre of the assembly. Another way of achieving some play in these other directions could be to choose more deformable material for the bearings 20.

1. A clamp assembly for attachment of a handlebar to a motorcycle body comprising clamp means adapted for secure clamping around a central location of a handlebar without play, respective support means adapted for mounting respective end portions of the clamp means, bearing elements disposed between each support means and the clamp means in order to permit relative axial rotation, a substantially rigid member adapted to be fixedly secured to and extending between the respective support means, and resilient means disposed between the clamp means and the rigid member so as to permit rotational play between the clamp means and the support means about the longitudinal axis of the central location of the handlebar, but minimize rotational play between the clamp means and the support means in the other directions, namely about vertical and horizontal axes.

2. A clamp assembly as set forth in claim 1 wherein the resilient means is in the form of a plurality of pads, inserts or washers connected only to the rigid member.

3. A clamp assembly as set forth in claim 1 wherein the resilient means is a pad which is of varying thickness and/or is contoured.

4. A clamp assembly as set forth in claim 1 wherein the first clamp means comprises a pair of clamp elements adapted for secure clamping in opposed disposition to embrace a central location of the handlebar without play.

5. A clamp assembly as set forth in claim 1 wherein the support means comprises two support cradles adapted for mounting respective end portions of the clamp means.

6. A clamp assembly as set forth in claim 5 wherein respective spacer elements are mounted between the rigid member and the respective support cradles.

7. A clamp assembly for attachment of a handlebar to a motorcycle body comprising clamp means adapted for secure clamping around a central location of a handlebar without play, respective support means adapted for mounting respective end portions of the clamp means, bearing elements disposed between each support means and the clamp means in order to permit relative axial rotation, a substantially rigid member adapted to be fixedly secured to and extending between the respective support means, and resilient means disposed between the clamp means and the rigid member so as to permit rotational play between the clamp means and the support means about the longitudinal axis of the central location of the handlebar, but permit only limited rotational play between the clamp means and the support means in one or both of the other directions, namely about vertical and horizontal axes.
